(19) United States
(12) Patent Application Publication
(10) Pub. No.: US 2013/0216720 A1
(43) Pub. Date: Aug. 22, 2013

(54) Coatings Having Enhanced Corrosion Performance and Method of Using the Same

(71) Applicants: Trevor Pearson, Cradley Heath West Midlands (GB); Nicole J. Micyus, South Lyon, MI (US)

(72) Inventors: Trevor Pearson, Cradley Heath West Midlands (GB); Nicole J. Micyus, South Lyon, MI (US)

(21) Appl. No.: 13/398,242

(22) Filed: Feb. 16, 2012

(51) Int. Cl. B05D 1/18; B82Y 30/00

(52) U.S. Cl. 427/435; 977/742

(57) ABSTRACT

A method of plating a part comprised of aluminum, alloys of aluminum, magnesium or alloys of magnesium to improve the corrosion resistance of the part. The method comprises the steps of plating the part with a plating bath comprising: (i) particles selected from the group consisting of polytetrafluoroethylene (PTFE), colloidal silica, colloidal graphite, ceramics, carbon nanotubes, silicon carbide, nano-diamond, diamond and combinations of one or more of the foregoing, which have been treated with a corrosion inhibitor and are dispersed in said plating bath; and (ii) metal ions to be plated. The dispersed particles co-deposit with the plated metal.

### FIELD OF THE INVENTION

The present invention relates generally to a method of coating an active metal substrate to improve the corrosion resistance of the active metal substrate.

### BACKGROUND OF THE INVENTION

Light metals such as magnesium and aluminum have wide commercial applications because they have a useful combination of high strength, low density and, in case of aluminum, high electrical conductivity. The aerospace industry (and increasingly the automotive industry) makes very wide use of these materials. However, these metals are highly reactive and rapidly form a thin passive oxide layer when in contact with the air. Because of the high activity of these metals in contact with more noble metals, which are often applied as coatings for fasteners and electrical connectors, a galvanic couple is established in which the exposed aluminum or magnesium is the anode in the corrosion cell. Thus, the exposed aluminum or magnesium substrate may catastrophically corrode either due to pitting corrosion, in cases where the more noble metal is applied as a coating to the substrate, or corrosion of the surrounding area, in cases where coated fasteners such as rivets or connectors are used in contact with the aluminum or magnesium substrate.

In the case of aluminum, cadmium plated connectors and fasteners have been used for many years. In many ways, cadmium is an ideal coating on aluminum in terms of its galvanic compatibility. The corrosion potential of cadmium is very similar to that of many aluminum alloys and lies within +/−50 mV of most of these. This means that the potential difference driving galvanic corrosion is very small. Cadmium has other useful properties in terms of lubricity and corrosion resistance and is easily passivated. Unfortunately, cadmium is also a very toxic metal and its use is becoming more and more restricted.

Extensive research has been done to evaluate cadmium alternatives for components, including connectors and fasteners. However, electrical connectors and fasteners present a unique problem, in that they must not only be corrosion and abrasion resistant, but they must also be electrically conductive to provide EMI/RFI shielding.

It has been suggested that zinc nickel alloys could be used as an alternative to cadmium because the corrosion potential of a zinc nickel alloy having a composition of 12 to 15% nickel is very similar to that of cadmium and so would be expected to perform well as a cadmium replacement. However, in order to function correctly, zinc nickel coatings require passivation treatment. In a corrosive environment, initial corrosion of the zinc nickel deposit is quite rapid and this causes formation of a compact corrosion product known as white “blush” which interacts with the passivate coating, forming an extremely corrosion resistant layer. Unfortunately, this layer is a very poor conductor of electricity and thus zinc nickel is not a suitable coating for use in fasteners and connectors where electrical integrity is of paramount importance, such as for radio frequency shielding.

Because of the unsuitability of zinc nickel for use as a coating for aluminum connectors, other coatings have been investigated, including coatings based on nickel. However, nickel is more noble than cadmium by about 150 mV and this could potentially cause significant contact corrosion issues in conjunction with aluminum. In this corrosion cell, the nickel would be the cathode and the aluminum would be anodically dissolved. Thus, there remains a need in the art for a coating which does not produce a high level of contact corrosion resistance in conjunction with light metal substrates, particularly aluminum substrates.

The potential difference between a bimetallic couple is a thermodynamic property and is simply a measure of the available energy to drive corrosion reactions. The actual rate of corrosion of a bimetallic couple is determined by kinetic factors. In particular, the rate of corrosion reactions is often determined by the rate of mass transport of the reacting species for the corrosion reaction. Anodic corrosion reactions usually involve dissolution of metal from the substrate. Often, this reaction can be limited by the formation of oxides on the surface of the corroding metal. Cathodic corrosion reactions may involve reduction of hydrogen ions (usually in acid media) or reduction of oxygen (in neutral and alkaline media). Most often in corrosive environments, the cathodic reduction reaction tends to be the rate-limiting step as the concentration of hydrogen ions or dissolved oxygen tends to be low.

Thus, there remains a need in the art for a coating for active metal substrates that provides improved corrosion resistance. In addition, there also remains a need in the art for a coating for fasteners and connectors that are in contact with the active metal substrate that provides improved corrosion resistance along with electrical integrity.

### SUMMARY OF THE INVENTION

It is an object of the present invention to provide a coating for active metal substrates that is galvanically compatible with the active metal substrate.

It is another object of the present invention to provide a coating for fasteners and connectors which is usable as a replacement for cadmium plating.

It is another object of the present invention to provide a coating for aluminum, alloys of aluminum, magnesium or alloys of magnesium that provides improved corrosion resistance.

It is another object of the present invention to provide a coating for an active metal substrate that maintains electrical integrity of the substrate.

To that end, in one embodiment, the present invention relates generally to a method of plating a part selected from the group consisting of aluminum, alloys of aluminum, magnesium, alloys of magnesium and connectors in contact with any of the foregoing, to improve the corrosion resistance of said part, the method comprising the steps of:

plating the part with a plating bath comprising:
i) particles selected from the group consisting of polytetrafluoroethylene (PTFE), colloidal silica, colloidal graphite, ceramics, carbon nanotubes, boron nitride, silicon carbide, nano-diamond, diamond and combinations of one or more of the foregoing, which have been treated with a corrosion inhibitor and are dispersed in said plating bath; and
ii) metal ions to be plated;

wherein the dispersed particles co-deposit with the plated metal.

### DETAILED DESCRIPTION OF THE PREFERRED EMBODIMENTS

The inventors of the present invention have discovered a method of incorporating a corrosion inhibitor in an evenly dispersed manner in an electrodeposited or electrolessly deposited metal coating such that the coating causes minimal contact corrosion in conjunction with active metals such as aluminum, aluminum alloys, magnesium and magnesium alloys.

In a preferred embodiment, the present invention relates generally to a method of plating a part selected from the group consisting of aluminum, alloys of aluminum, magnesium, alloys of magnesium, and connectors in contact with any of the foregoing, to improve the corrosion resistance of said part, the method comprising the steps of:

plating the part with a plating bath comprising:
i) particles selected from the group consisting of polytetrafluoroethylene (PTFE), colloidal silica, colloidal graphite, ceramics, carbon nanotubes, boron nitride, silicon carbide, nano-diamond; diamond and combinations of one or more of the foregoing, which have been treated with a corrosion inhibitor, such that the corrosion inhibitor is adsorbed on the surface of said particles, and said particles are dispersed in said plating bath; and
ii) metal ions to be plated;

wherein the dispersed particles co-deposit with the plated metal.

The particles can be selected such that the properties of the deposit are also improved in a desired manner. Suitable particles include, but are not limited to, polytetrafluoroethylene (PTFE), colloidal silica, colloidal graphite, carbon nanotubes, boron nitride, ceramics, silicon carbide, nano-diamond, diamond and the like as well as combinations of one or more of the foregoing. In a preferred embodiment, the particles comprise PTFE. The particles have an average particle size of between about 0.2 μm and about 10 μm.

In a preferred embodiment, the corrosion inhibitor is a cationic surfactant and the particles are treated with the cationic surfactant so that the cationic surfactant is adsorbed on the particles. The inventors of the present invention have discovered that by treating particles with a cationic surfactant either before their inclusion in the plating bath or in the plating bath itself, when these particles are dispersed in a plating bath, the particle dispersion readily co-deposits with the metal due to the positive charge on the particles. The cationic surfactant adsorbed on these particles then inhibits cathodic reduction reactions on the co-deposited metal such that the galvanic and contact corrosion properties of the metal are improved.

The cationic surfactant typically has an organic anion. For example, quaternary ammonium, quaternary phosphonium and quaternary sulfonium compounds having an alkyl chain with 6 to 32 carbon atoms, can be used. The organic anion may be a carboxylate, phosphonate or sulfonate anion. In a preferred embodiment, the cationic surfactant may be selected from the group consisting of alkyl amines, alkyl diamines, and alkyl imidazoles. More preferably, the corrosion inhibitors may be selected from the group consisting of quaternary amine compounds, including quaternary imidazoles, quaternary alkyl amines such as cetyl trimethylammonium compounds and quaternary aromatic alkyl amines. Other suitable corrosion inhibitors include centrimonium bromide (CAS# 57-09-0) and stearalkonium chloride (CAS# 122-19-0). Preferably, one of the alkyl groups on the amine or quaternary amine compound is between 6 and 18 carbon atoms in length and more preferably is between about 12 and 16 carbon atoms in length. Quaternary cationic fluorosurfactants are also effective for use in compositions of the present invention.

Exemplary cationic surfactants include quaternary ammonium salts such as alkyl trimethyl ammonium halides, alkyl trimethylammonium tosylates, N-alkyl pyridinium halides and cetyltrimethylammonium p-toluenesulfonate. Alkyl trimethylammonium halides include dodecyl trimethyl ammonium chloride, cetyl trimethyl ammonium salts of bromide and chloride, hexadecyl trimethyl ammonium salts of bromide and chloride, alkyl dimethyl benzyl ammonium salts of chloride and bromide and the like. Alkyl trimethylammonium tosylates include octyl trimethylammonium tosylate, decyl trimethylammonium tosylate, dodecyl trimethylammonium tosylate, myristyl trimethylammonium tosylate, and cetyl trimethylammonium tosylate. N-alkyl pyridinium halides include decyl pyridinium chloride, dodecyl pyridinium chloride, and cetyl pyridinium chloride. In a preferred embodiment, the cationic surfactant comprises cetyltrimethylammonium p-toluenesulfonate.

As described herein, the PTFE or other particles are treated with a corrosion inhibitor, which may preferably be a cationic surfactant, such as a quaternary alkyl amine surfactant, and this dispersion is added to the plating bath.

The method of treating the particles includes either (i) dissolving the corrosion inhibitor in a solvent such as water and contacting the particles with the solution for a time effective to adsorb the corrosion inhibitor to the surface of the particles and thereafter separating the particles from the solution, or (ii) treating the particles in-situ in the plating bath by adding the corrosion inhibitor to the plating bath. The important aspect of this is to ensure that the corrosion inhibitor is adsorbed on the surface of the particles.

In a preferred embodiment, the plating bath is an electroless nickel plating bath and the active metal substrate is aluminum or an aluminum alloy. The plating bath is used to apply a coating to the active metal substrate in order to improve the contact corrosion properties. The PTFE particles additionally confer lubricity and wear resistance to the coating. In this instance, approximately 2-12 weight percent of particles is present in the plated coating, more preferably approximately 7-10 weight percent of the particles is present.

The corrosion inhibitor is used to provide improved corrosion properties to the coating when the coating is in contact with the substrate and the particles themselves are simply the vehicle to disperse the corrosion inhibitor throughout the coating to impart corrosion resistance to the coating. As described herein, various particles may also be used in the practice of the invention but PTFE particles are of particular use in many applications where contact corrosion resistance is important. One example of this is in the coating of aluminum electrical connectors where the lubricity and wear resistance of the coating is also important. However, the present invention is not limited to PTFE particles and any particles of suitable size and functionality can be used in the practice of the present invention.

The present invention applies specifically to a metal coating containing dispersed particles with a corrosion inhibitor adsorbed on the surface of the particles, wherein the coating is applied to a substrate comprising an active metal such as aluminum or its alloys, or magnesium or its alloys and wherein the metal coating containing the dispersed particles is more noble than the substrate material. The metal coating containing dispersed particles with a corrosion inhibitor adsorbed on the surface of said particles can also be applied to connectors which are in contact with the active metal such as aluminum, magnesium or their alloys. Such connectors can be either metal or plated plastic. What is important is for the metal coating of this invention to be the interface between the active metal and the connector. In a preferred embodiment, the metal coating is an electroless nickel deposit.

The present invention will now be described with reference to the following non-limiting examples.

As described in the following examples, the contact corrosion properties of various nickel coatings including electrodeposited nickel, electroless nickel (high phosphorus) and electroless nickel/PTFE composite coatings were investigated. It was determined that the results were as expected from the electroless nickel and electrodeposited nickel coatings and considerable contact corrosion was observed. However, it was surprisingly found that nickel/PTFE with corrosion inhibitor adsorbed on the surface of the PTFE composite coatings provided a much better result with little observed contact corrosion.

### Comparative Example 1

An aluminum panel consisting of a 3003 H14 aluminum alloy was coated with 20 microns of a high phosphorus electroless nickel using the MacDermid Niklad 4100 process to produce a deposit consisting of nickel with 10-12% phosphorus. On top of this was plated a further 5 microns of a high phosphorus electroless nickel deposit from another MacDermid process (Elnic 101).

This panel was then masked to expose a surface area of 50 cm² and immersed in a beaker containing a 3.5% solution of sodium chloride solution for an equilibrium period. An uncoated aluminum panel was masked in a similar manner and was also immersed in the same beaker. The beaker was stirred using a magnetic stirrer. The two panels were then connected together through a zero resistance ammeter (ZRA). The ZRA was then used to measure the current flowing between these panels after a period of time sufficient for the current to reach an equilibrium value and the corrosion current was recorded. The corrosion current density in this case was determined to be 152 μA/cm².

### Comparative Example 2

An aluminum panel was prepared as in Comparative Example 1 but substituting the 5 microns of Elnic 101 with 5 microns of nickel deposited electrolytically from a sulfamate plating bath. The panel was tested in the same manner as the panel in Comparative Example 1. In this case, the corrosion current density was determined to be 149 μA/cm².

### Example 1

An aluminum panel was prepared as in Comparative Example 1, but in this instance a PTFE dispersion was added to the Elnic 101 plating bath in order to produce a composite coating.

The PTFE dispersion was produced by mixing the PTFE particles with cetyltrimethylammonium p-toluenesulfonate and then adding the mixture to the foregoing plating bath at a concentration of 7.0 g/l.

The panel was plated using the foregoing plating bath to a thickness of 5 μm of nickel/PTFE and then tested using the same method described above for Comparative Examples 1 and 2. In this case, the corrosion current density was determined to be 92 μA/cm². This represents a substantial reduction of the corrosion current when compared to the values obtained in the comparative examples.

These panels were then subjected to various electrochemical tests as outlined below.

### Corrosion Potential

The corrosion potential of the deposits was measured using a silver/silver chloride reference electrode after an equilibrium period of 30 minutes in a 3.5% sodium chloride solution. The measurement was performed using an EG&G model 263a potentiostat.

The results of the above described tests are shown in Table 1.

TABLE 1
Static corrosion potentials of different coatings vs Ag/AgCl reference

| | Corrosion |
|---|---|
| | Potential |
| Coating | (V) |
| Elnic 101 (high phosphorus electroless nickel) | −0.453 |
| Coating containing the PTFE dispersion | −0.468 |
| Electrodeposited nickel coating | −0.415 |

It can be seen from these results that all of the coatings had similar corrosion potentials and that they are close to what would be expected to be calculated from the standard potential of nickel (0.479V vs Ag/AgCl).

### Polarization Measurement

Initially, potentiodynamic scans were carried out between a potential of −1.2V to +0.3V with reference to an Ag/AgCl electrode at a scan rate of 1 mV/sec using a model 263a potentiostat. A 3.5% sodium chloride electrolyte was used. However, it was found that the apparent corrosion potential determined by this method differed considerably from that which was determined under static conditions. It is possible that the initial high cathodic potential had “activated” the nickel surface so these scans would not really be representative of results in practice. In order to prevent this type of error, a current/voltage curve was constructed by taking potentiostatic measurements at 100 mV intervals over the potential range shown above. The readings were taken after 30 minutes equilibration using a different area of the test panel for each measurement.

The anodic branch of the polarization curves showed that the Elnic 101 deposit is far more passive than the other two coatings. The sulfamate nickel also demonstrates passivity between its corrosion potential and a potential of around 0.05V. The coating containing the PTFE dispersion however shows no tendency towards passivation and demonstrates typical Tafel behavior. This is surprising because the composition of the nickel matrix containing the PTFE particles is similar to the Elnic coating.

The cathodic branch of the polarization curves was equally interesting. Here, it was observed that the electrodeposited nickel coating from the sulfamate electrolyte was the most “active” cathode and supported higher current densities over a wide potential range. The Elnic coating was a less effective cathode, but the coating containing the PTFE dispersion was the least effective cathode. This is important because in a corrosion couple with aluminum, the nickel deposit is the cathode in the corrosion cell.

### Electrochemical Impedance Spectroscopy

EIS spectra were collected over a frequency range of 60 KHz to 0.1 Hz using an amplitude of 10 mV and a polarizing potential of −0.8 V vs Ag/AgCl in a 3.5% sodium chloride solution. The measurements were collected using a Solartron frequency response analyzer in conjunction with an EG&G model 263a potentiostat. The polarizing potential of 0.8V was chosen since it corresponds approximately to the expected cathodic potential of nickel in contact with aluminum. Following collection of the spectra, equivalent circuit modeling was carried out using the Z-View electrochemical research software.

In order to model the equivalent circuit, two possibilities were considered. The first model considered was to treat the high frequency time constant as a Randles circuit and the low frequency time constant as a finite Warburg impedance (due to mass transport control of the cathodic reduction process). An alternative model was to consider treating the electrode as a coated surface, such as an oxide.

The result of the modeling was that the best data fit was given by the Randles/finite Warburg model. The fit quality was almost perfect for the sulfamate and Elnic coatings but was not so good for the coating containing the PTFE dispersion. This suggests that the equivalent circuit for the coating containing the PTFE dispersion was somewhat different. Porosity in the coating containing the PTFE dispersion could again possibly account for this difference. The parameters determined by the equivalent circuit modeling and data fitting are shown in Table 2.

These parameters clearly show a lower value for double layer capacitance for the coating containing the PTFE dispersion. Generally speaking, values of Cdl for a corroding metal lie between 20 and 60 μF/cm². Both the sulfamate coating and the Elnic coating produced values within this range (51 and 29 μF/cm² respectively). However, the coating containing the PTFE dispersion produced a capacitance value much lower than this at 11.4 μF/cm². There are two possibilities for this observation—either the “real” surface area of the electrode was much lower than the nominal 1 cm² sample surface area, or there is an adsorbed species on the surface of the nickel causing an increase in the thickness of the double layer. In the nickel/PTFE composite coating, the PTFE particles occupy approximately 30% of the total coating volume so it is conceivable that they could occupy a significant surface area. However, there is no chemical bonding between the nickel phase and the PTFE phase so it would be expected that some porosity would exist on the coating containing the PTFE dispersion (induced by the co-deposition of particles). This would help to explain the anodic behavior of the coating containing the PTFE dispersion in terms of the lack of passivity.

TABLE 2
Electrochemical Parameters for Circuit Modeling

| | Coating | | |
|---|---|---|---|
| | containing | | |
| | the PTFE | | |
| Parameter | dispersion | Elnic | Sulfamate |
| Solution resistance (Rs) Ω | 5.2 | 4.8 | 5.0 |
| Charge transfer resistance | 58 | 966 | 479 |
| (Rct) Ω/cm² | | | |
| Double layer capacitance | 11.4 | 29 | 51 |
| (Cdl) μF/cm² | | | |
| Ws-R | 4148 | 8455 | 3726 |
| Ws-T | 0.2445 | 0.4790 | 0.3126 |
| Ws-P | 0.536 | 0.505 | 0.526 |

Ws-R is the Warburg coefficient, Ws-T is a diffusion parameter (d/D^{0.5} where d=thickness of the Nernst diffusion layer and D is the diffusion coefficient) and Ws-P is a symmetry factor (generally around 0.5).

It can be seen that the coating containing the PTFE dispersion had a lower charge transfer resistance than the other two coatings for the cathodic reaction. However, this is not the rate determining step for the overall reaction since it is mass transport controlled.

In terms of the cathodic reaction occurring during the test, there are two possibilities. One is the reduction of hydrogen ions to hydrogen and the other is the reduction of dissolved oxygen. In view of the low concentration of hydrogen ions in the neutral solution (10⁻⁷ M would give an estimated limiting current density of no more than 100 μA/cm²), the most likely cathodic reaction is oxygen reduction (10 ppm of dissolved oxygen would give an estimated limiting current density of around 1 mA/cm²). This would proceed according to the following reaction:

O₂+2H₂O+4e⁻→4OH⁻

A possible explanation of the behavior of the coating containing the PTFE dispersion lies in the method of preparation of the PTFE dispersion. In order to attain a substantial degree of particle incorporation into the electroless nickel coating, it is necessary for the PTFE particles to carry a net positive charge. This can be achieved by the adsorption of a corrosion inhibitor on the surface of the PTFE such as a quaternary alkyl amine compound like cetyltrimethylammonium p-toluenesulfonate. It is believed that the low double layer capacitance of the coating is due to the adsorption of this material onto the exposed nickel.

Quaternary surfactants are widely used as corrosion inhibitors, which is believed to be the reason for the lack of cathodic efficiency of the coating. It is this factor that is believed to confer the useful properties of the coating as a cadmium replacement on aluminum connectors. Thus, the use of co-deposited particles coated with a corrosion inhibitor is shown to modify the corrosion kinetics of metal coatings.

### Measurement of Bimetallic Corrosion Current

An uncoated aluminum Q panel was immersed in a 3.5% sodium chloride solution and connected to a test panel having one of the coatings under test via a zero-resistance ammeter (ZRA). The immersed area of both electrodes was 50 cm². The corrosion current was measured after an equilibration period of 1 hour in a stationary and stirred (by magnetic stirrer) electrolyte.

The results of the corrosion current measurements are shown in Table 3. It can be seen from these results that in both stirred and unstirred solutions, the coating containing the PTFE particles gave the lowest rate of corrosion. This is in agreement with the findings of the polarization studies and the EIS experiments.

TABLE 3
Bimetallic Corrosion Current Measurements

| | Coating containing | | |
|---|---|---|---|
| Agitation | the PTFE dispersion | Elnic | Sulfamate |
| Unstirred | 720 μA | 980 μA | 960 μA |
| Stirred | 4.8 mA | 7.6 mA | 7.5 mA |

It is interesting to note that the equilibrium values of corrosion current are an order of magnitude lower in unstirred media. This illustrates that the corrosion process is under diffusion control.

Thus, it can be seen that nickel/phosphorus/PTFE coatings offer a replacement for cadmium coatings on aluminum connectors in terms of contact corrosion properties, lubricity and electrical properties. In addition, the use of the PTFE in the coating composition also provides a low coefficient of friction and excellent lubricity.

1. A method of plating a part selected from the group consisting of aluminum, alloys of aluminum, magnesium, alloys of magnesium and connectors in contact with any of the foregoing, to improve the corrosion resistance of said part, the method comprising the steps of:
plating the part with a plating bath comprising:
i) particles selected from the group consisting of polytetrafluoroethylene (PTFE), colloidal silica, colloidal graphite, ceramics, carbon nanotubes, boron nitride, silicon carbide, nano-diamond, diamond and combinations of one or more of the foregoing, which have been treated with a corrosion inhibitor, such that the corrosion inhibitor is adsorbed on the surface of said particles, and said particles are dispersed in said plating bath; and
ii) metal ions to be plated;
wherein the dispersed particles co-deposit with the plated metal.

2. The method according to claim 1, wherein the corrosion inhibitor is a cationic surfactant and the particles are treated with the cationic surfactant so that the cationic surfactant is adsorbed on the particles.

3. The method according to claim 1, wherein the particles comprise PTFE.

4. The method according to claim 2, wherein the cationic surfactant comprises an organic anion selected from carboxylate, phosphonate and sulfonate anions.

5. The method according to claim 4, wherein the cationic surfactant comprises an alkyl amine, alkyl diamine or alkyl imidazole.

6. The method according to claim 5, wherein the cationic surfactant comprises a quaternary amine compound selected from the group consisting of quaternary imidazoles, quaternary alkyl amines, quaternary aromatic alkyl amines, and combinations of one or more of the foregoing.

7. The method according to claim 6, wherein one of the alkyl groups on the amine or qua mary amine compound is between 6 and 18 carbon atoms in length.

8. The method according to claim 7, wherein one of the alkyl groups on the amine or quaternary amine compound is between 12 and 16 carbon atoms in length.

9. The method according to claim 6, wherein the quaternary amine compound comprises a quaternary ammonium salt selected from alkyl trimethyl ammonium halides, alkyl trimethylammonium tosylates, N-alkyl pyridinium halides and cetyltrimethylammonium p-toluenesulfonate.

10. The method according to claim 9, wherein the quaternary amine compound comprises cetyltrimethylammonium p-toluenesulfonate.

11. The method according to claim 1, wherein the particles have an average particle diameter of between about 02. μm to about 10 μm.

12. The method according to claim 1, wherein the metal ions comprise nickel.

13. The method according to claim 1, wherein the plating bath is an electroless nickel plating bath.
